(19) United States
(12) Patent Application Publication
(10) Pub. No.: US 2025/0383194 A1
(43) Pub. Date: Dec. 18, 2025

(54) SETTING DEVICE, SENSOR, SETTING METHOD, AND NON-TRANSITORY COMPUTER READABLE MEDIUM STORING PROGRAM

(71) Applicant: OMRON Corporation, Kyoto-shi (JP)

(72) Inventors: Kazunori OKAMOTO, Kyoto-shi (JP); Minoru HASHIMOTO, Kyoto-shi (JP)

(21) Appl. No.: 19/219,207

(22) Filed: May 27, 2025

(30) Foreign Application Priority Data
Jun. 13, 2024 (JP) 2024-096167

(51) Int. Cl. G01B 11/00; G01B 11/02; G05D 1/229; G05D 103/00

(52) U.S. Cl. CPC G01B 11/002; G01B 11/026; G05D 1/2295; G05D 2103/00

(57) ABSTRACT

A setting device for a sensor that measures a distance to an object by two- dimensionally scanning light at a first angular interval includes a distance map generation unit that generates a distance map with respect to the light that is scanned, based on a measured distance to the object and using a plurality of beams sampled at a second angular interval, a display control unit that updates the distance map displayed on a display unit in a predetermined display cycle, a reception unit that receives an instruction of a user, and a setting unit that sets at least one of the second angular interval and the predetermined display cycle in accordance with the instruction of the user received by the reception unit.

### CROSS-REFERENCE TO RELATED APPLICATION

This application claims the benefit of priority to Japanese Patent Application Number 2024-096167 filed on June 13, 2024. The entire contents of the above-identified application are hereby incorporated by reference.

### TECHNICAL FIELD

The present invention relates to a setting device, a sensor, a setting method, and a program.

### BACKGROUND ART

When a hazard such as a machine or a robot work together with a person, a virtual detection area is set near the hazard, and a sensor monitors whether or not an object has entered the detection area. Patent Document 1 describes a detection condition setting method for a sensor for detecting an approach of an approaching object to a machine.

### CITATION LIST

### PATENT LITERATURE

Patent Literature 1: Japanese Unexamined Patent Publication 2021-186946

### SUMMARY OF INVENTION

### TECHNICAL PROBLEM

In recent years, the resolution of a sensor has improved, and the frequency of updating data output from the sensor has increased. Therefore, an amount of information output from the sensor has been increasing. When the angular resolution and the display cycle are high, it takes time to perform drawing and thus it takes time for a user to obtain information that the user desires to view. Further, when the angular resolution and the display cycle are high, the load of display processing increases. Although an amount of information output from the sensor is increasing, the information that the user desires to view differs between users. The present invention has been made in view of the circumstances described above, and an object thereof is to provide a technique that can display information that a user desires to view.

### SOLUTION TO PROBLEM

According to an aspect of the present invention, a setting device for a sensor that measures a distance to an object by two-dimensionally scanning light at a first angular interval is provided. The setting device includes a distance map generation unit configured to generate a distance map with respect to the light that is scanned, based on a measured distance to the object and using a plurality of beams sampled at a second angular interval, a display control unit configured to update the distance map displayed on a display unit in a predetermined display cycle, a reception unit configured to receive an instruction of a user, and a setting unit configured to set at least one of the second angular interval and the predetermined display cycle in accordance with the instruction of the user received by the reception unit. According to the setting device described above, since at least one of the second angular interval and the predetermined display cycle is set in accordance with the instruction of the user, a distance map that the user desires to view can be displayed on the display unit.

The reception unit receives, from the user, a change instruction to change a setting of at least one of the second angular interval and the predetermined display cycle, and the setting unit changes the setting of at least one of the second angular interval and the predetermined display cycle in accordance with the change instruction received by the reception unit. According to the setting device described above, since the setting of at least one of the second angular interval and the predetermined display cycle is changed in accordance with the change instruction, the distance map that the user desires to view can be displayed on the display unit.

The distance map is expressed by a line segment connecting two measurement points measured by adjacent beams among the plurality of beams sampled. As a result, the distance map expressed by the line segment connecting two measurement points can be displayed on the display unit.

The reception unit receives a selection of display or non-display of the line segment in accordance with a type of the plurality of beams, and the display control unit switches between display and non-display of the line segment on the display unit based on the selection of display or non-display of the line segment. By switching between display and non-display of the line segment on the display unit, only the line segment that the user desires to view can be displayed on the display unit.

The setting device includes a determination unit configured to determine whether or not an abnormal beam is present in the plurality of beams. The distance map is expressed by a first line segment connecting two measurement points measured by adjacent beams among the plurality of beams other than the abnormal beam, and by a second line segment connecting a measurement point measured by the abnormal beam among the plurality of beams, and a measurement point measured by a beam adjacent to the abnormal beam among the plurality of beams, and a color of the first line segment is different from a color of the second line segment. The user can reliably ascertain that the abnormal beam has been generated by visually checking the distance map displayed on the display unit.

The reception unit receives a selection of display or non-display of the second line segment, and the display control unit switches between display and non-display of the second line segment on the display unit based on the selection of display or non-display of the second line segment. By switching between display and non-display of the second line segment on the display unit, the second line segment can be switched between being displayed on the display unit and not being displayed on the display unit.

The setting device includes a storage unit configured to store a display setting related to the distance map displayed on the display unit. After a setting tool is restarted, the display control unit displays the distance map on the display unit based on the display setting stored in the storage unit. As a result, after the setting tool is restarted, the user can check the distance map based on the display setting stored in the storage unit.

The display control unit simultaneously displays, on the display unit, the distance map and a setting screen of a detection area for detecting entry of the object. The user can visually check the detection area setting screen while checking the distance map.

The setting device includes an area setting unit configured to set a detection area for detecting entry of the object. The detection area is set independently of the second angular interval and the predetermined display cycle. Therefore, the settings of the second angular interval and the predetermined display cycle do not affect the setting of the detection area.

According to an aspect of the present invention, a sensor including the setting device described above is provided. The present invention can also be regarded as a setting method including at least a portion of the processing described above, a program for causing a computer included in a setting device to execute at least a portion of the processing described above, or a computer-readable storage medium having such a program recorded in a non-transitory manner. Further, the present invention can be regarded as a setting system including at least a portion of the processing described above. The configurations and processing described above can be combined with each other to configure the present invention as long as no technical contradiction arises.

### ADVANTAGEOUS EFFECTS OF INVENTION

According to the present invention, it is possible to display information that a user desires to view.

### BRIEF DESCRIPTION OF DRAWINGS

FIG. 1 is a schematic configuration diagram of a sensor system.

FIG. 2 is a diagram illustrating a configuration of a sensor.

FIG. 3 is a functional block diagram of a setting device.

FIG. 4 is an explanatory diagram of a method of drawing a distance map.

FIG. 5 is a diagram illustrating an example of the distance map.

FIG. 6 is a diagram illustrating an example of the distance map.

FIG. 7 is a diagram illustrating an example of the distance map.

FIG. 8 is a diagram illustrating an example of a setting screen of a second angular interval and a predetermined display cycle.

### DESCRIPTION OF EMBODIMENTS

Hereinafter, application examples and embodiments will be described with reference to the drawings. The application examples and embodiments described below are aspects of the present application, and do not limit the scope of rights of the present application.

### Application Example

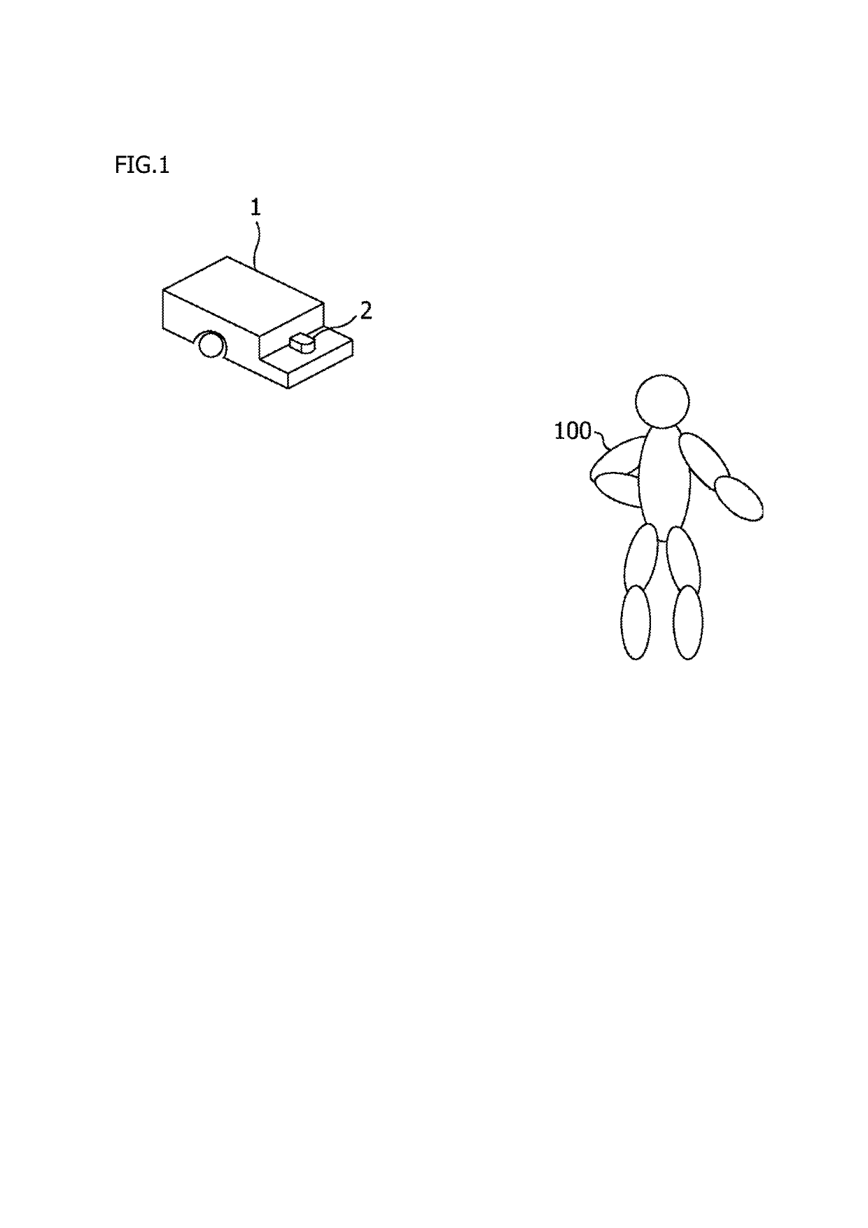

FIG. 1 is a schematic configuration diagram of a sensor system (safety monitoring system). In the sensor system illustrated in FIG. 1, in an environment in which a hazard such as a mobile robot 1 and a worker (person) 100 work together, for example, at a production site such as a factory, the mobile robot 1 is controlled while ascertaining the movement of the worker 100. The mobile robot 1 is, for example, a traveling device such as an autonomous mobile robot (AMR) or an automated guided vehicle (AGV). The mobile robot 1 may be a transport device in which a manipulator is attached to a traveling device. A sensor 2 is installed at a chosen position of the mobile robot 1. In FIG. 1, the sensor 2 is installed at a front portion of the mobile robot 1.

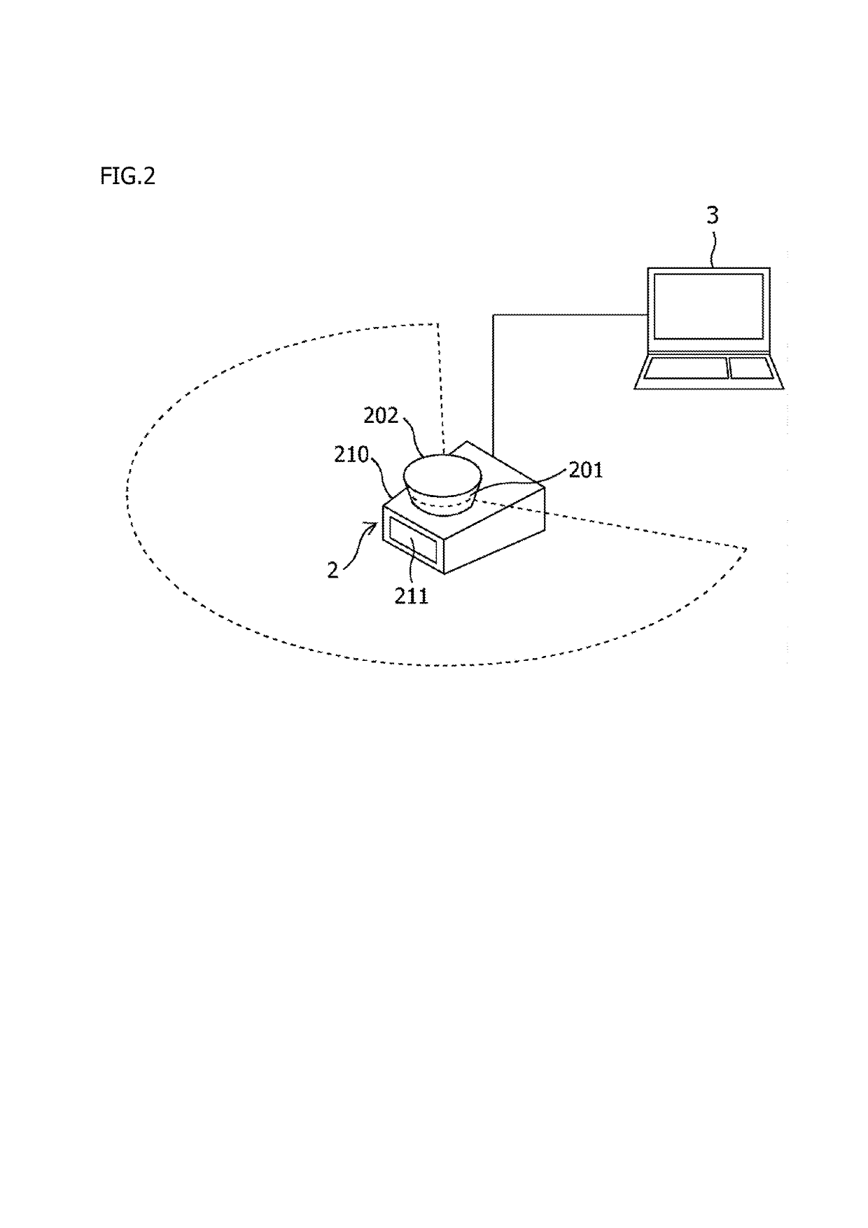

The sensor 2 is also referred to as a safety laser scanner or a laser scanner and is a safety scanner compliant with safety standards. The sensor 2 is a measurement sensor that measures a distance to an object by two-dimensionally scanning light at a first angular interval. The first angular interval is, for example, an interval of 0.1 degrees, but is not limited thereto. FIG. 2 is a diagram illustrating a configuration of the sensor 2. The sensor 2 includes a window 201 and a top surface portion 202. The sensor 2 has a structure in which the window 201 having an inverted truncated cone shape is provided on a main body portion 210. The top surface portion 202 is provided on the window 201. The window 201 illustrated in FIG. 2 has a tapered shape that widens from one opening to the other opening, but is not limited to this shape, and the window 201 may have a cylindrical shape.

The window 201 is transparent or translucent (colored with a predetermined transmittance). The window 201 is made of a material that transmits laser light, and is a member for protecting an optical system such as a mirror. The main body portion 210 includes a light source, an optical system, a light reception unit, a control circuit, an indicator lamp, and the like. Laser light output from the light source is reflected by a mirror rotating at high speed inside the window 201. In this way, the sensor 2 can scan a predetermined range. Reflected light reflected by an object is guided to the light reception unit via the optical system and photoelectrically converted. A broken line in FIG. 2 indicates the scanning range of the laser light. In the configuration example illustrated in FIG. 2, a display 211 is provided at the outer surface of the main body portion 210. The display 211 displays information regarding the state of the sensor 2, information regarding a warning to the outside, and the like.

The sensor 2 can be connected to a setting device (monitoring device) 3 by wire or wirelessly. The setting device 3 monitors a measurement state of the sensor 2 and performs predetermined settings on the sensor 2. The setting device 3 is a controller (information processing device) that functions as a processing device and a display device (display). The setting device 3 may be constituted by a dedicated device or may be constituted by a general-purpose computer. In the present embodiment, the setting device 3 is constituted by installing a setting tool (software program) of the sensor 2 in a generic personal computer. In this case, the setting device 3 includes hardware resources such as a processor (CPU), a memory, a storage, a communication I/F, an input device, and a display device. A function of the setting device 3 as a processing device to be described later is realized by loading a program stored in the storage into the memory and executing the program by the processor. Examples of the input device include a keyboard, a mouse, a touch panel, and the like. Note that the configuration of the setting device 3 is not limited to this example. For example, all or some of the functions of the setting device 3 may be configured by a circuit such as an application-specific integrated circuit (ASIC) or a field programmable gate array (FPGA), or all or some of the functions of the setting device 3 may be executed by a cloud server or another device.

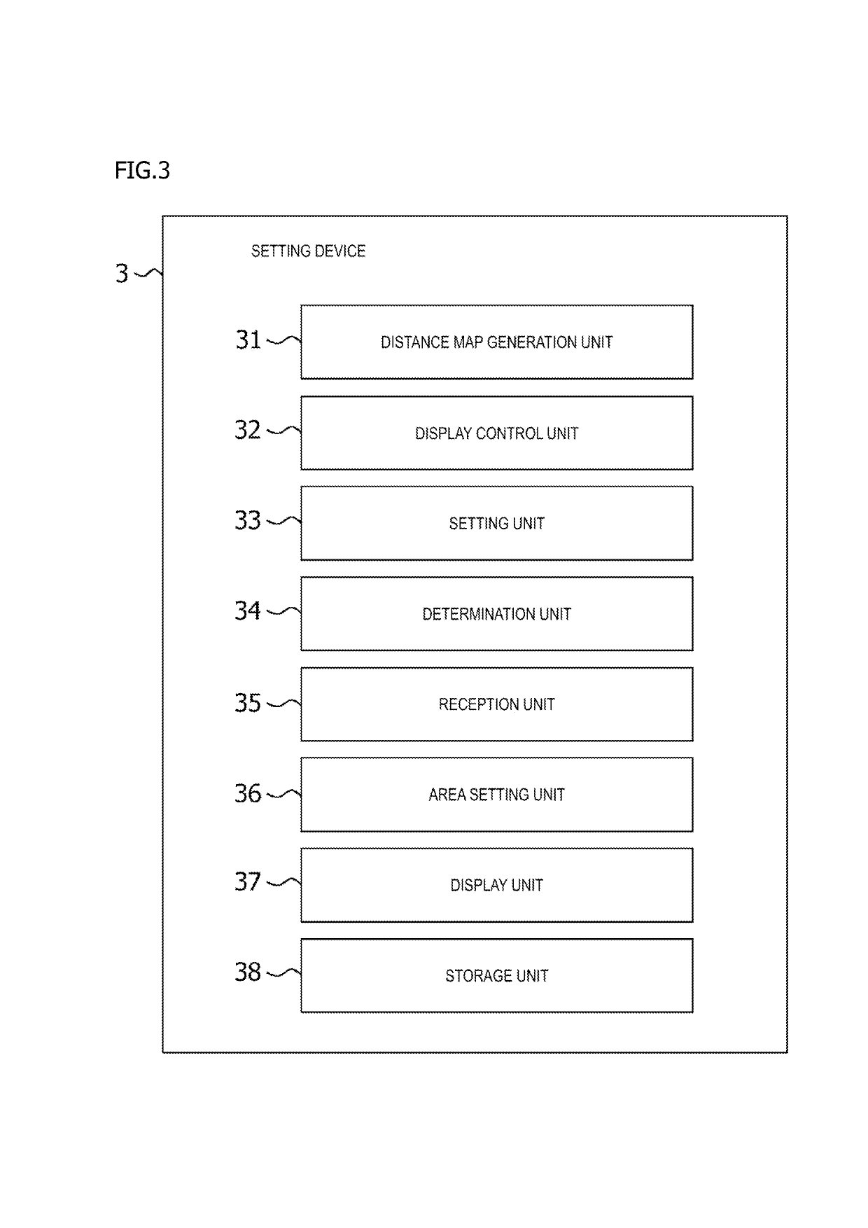

FIG. 3 is a functional block diagram of the setting device 3. The setting device 3 includes, as main functions, a distance map generation unit 31, a display control unit 32, a setting unit 33, a determination unit 34, a reception unit 35, an area setting unit 36, a display unit 37, and a storage unit 38. The distance map generation unit 31 generates a distance map with respect to light scanned by the sensor 2, based on a distance to an object and using a plurality of beams sampled at a second angular interval. The display control unit 32 displays the distance map on the display unit 37 and updates the distance map displayed on the display unit 37 at a predetermined display cycle (display interval). The setting unit 33 sets at least one of the second angular interval and the predetermined display cycle in accordance with an instruction of the user received by the reception unit 35. The setting unit 33 stores the set second angular interval and predetermined display cycle in the storage unit 38. The determination unit 34 determines whether or not an abnormal beam is present in the plurality of beams. The reception unit 35 functions as a user interface for receiving various instructions from the user. The area setting unit 36 sets a detection area for detecting entry of an object. The display unit 37 displays various types of information and data. The storage unit 38 stores various types of information and data.

The sensor 2 may send, to the setting device 3, all the beam information obtained by two-dimensionally scanning the light at the first angular interval. The sensor 2 may thin out, based on the second angular interval, the beam information obtained by two-dimensionally scanning the light at the first angular interval, and then may send the thinned-out beam information to the setting device 3. The sensor 2 may thin out, based on the predetermined display cycle, the beam information obtained by two-dimensionally scanning the light at the first angular interval, and then may send the thinned-out beam information to the setting device 3.

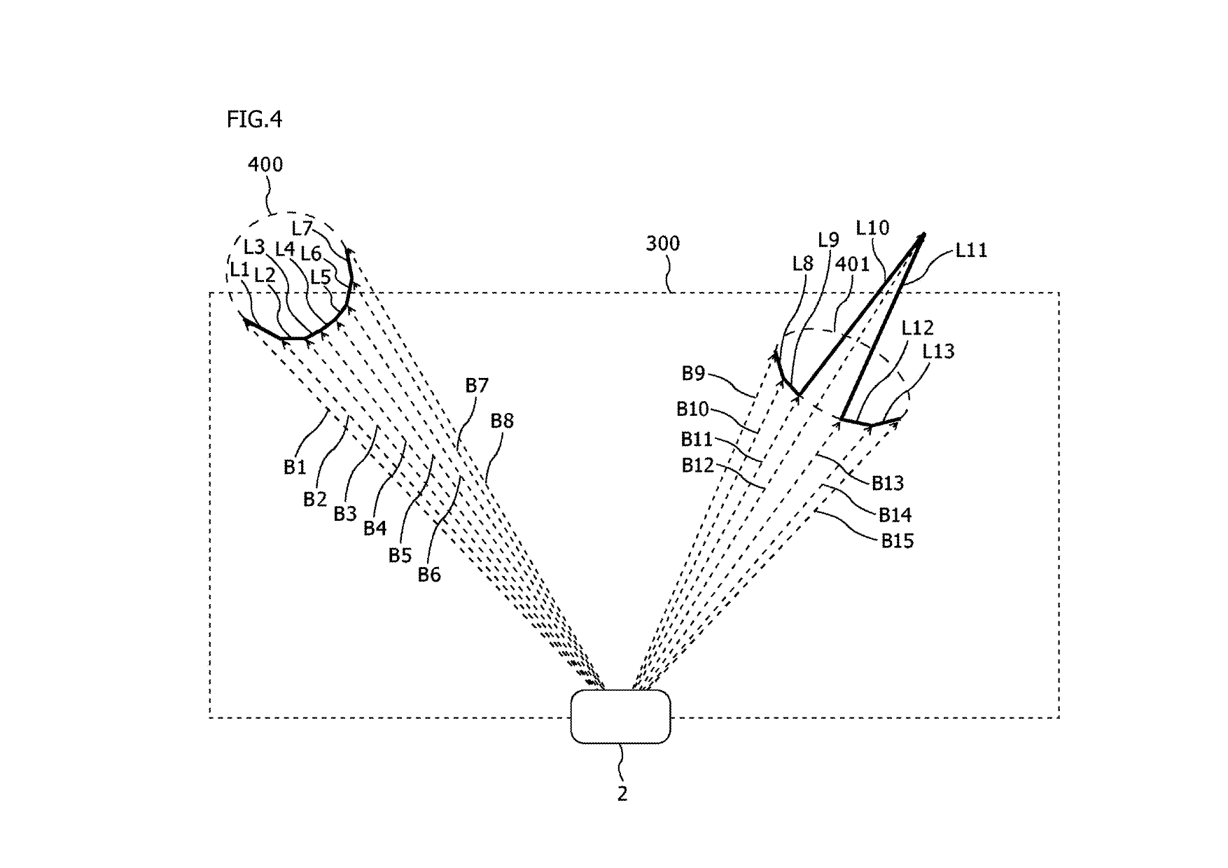

FIG. 4 is an explanatory diagram of a method of drawing the distance map. As illustrated in FIG. 4, a protection area 300 is set as the detection area (safety area). The detection area is a virtual two-dimensional region for detecting an approach of an object to the sensor 2, and is set in at least a part of the surrounding area of the sensor 2. When no object (intruding object) is present in the protection area 300, the operation of the mobile robot 1 is permitted. For example, when no object is present in the protection area 300, the sensor 2 outputs, to the mobile robot 1, a safety signal indicating that the mobile robot 1 is permitted to operate. The protection area 300 is set by the area setting unit 36. In FIG. 4, a portion of an object 400 has entered the protection area 300, and an entire portion of an object 401 has entered the protection area 300.

The distance map is generated with respect to the light scanned by the sensor 2 based on the distance to the object and using the plurality of beams sampled at the second angular interval. The distance map illustrated in FIG. 4 is expressed by line segments each connecting two measurement points measured by adjacent beams among the plurality of sampled beams.

The object 400 is irradiated with beams B1 to B8. A measurement point measured by the beam B1 (hereinafter also referred to as a first measurement point) and a measurement point measured by the beam B2 (hereinafter also referred to as a second measurement point) are connected by a line segment L1. The measurement point measured by the beam B2 and a measurement point measured by the beam B3 (hereinafter also referred to as a third measurement point) are connected by a line segment L2. The measurement point measured by the beam B3 and a measurement point measured by the beam B4 (hereinafter also referred to as a fourth measurement point) are connected by a line segment L3. The measurement point measured by the beam B4 and a measurement point measured by the beam B5 (hereinafter also referred to as a fifth measurement point) are connected by a line segment L4. The measurement point measured by the beam B5 and a measurement point measured by the beam B6 (hereinafter also referred to as a sixth measurement point) are connected by a line segment L5. The measurement point measured by the beam B6 and a measurement point measured by the beam B7 (hereinafter also referred to as a seventh measurement point) are connected by a line segment L6. The measurement point measured by the beam B7 and a measurement point measured by the beam B8 (hereinafter also referred to as an eighth measurement point) are connected by a line segment L7.

When two measurement points measured by adjacent beams among the plurality of beams are present in the protection area 300, a line segment connecting the two measurement points is drawn in a first color (for example, red) on the distance map. As illustrated in FIG. 4, since the first to sixth measurement points are present in the protection area 300, the line segments L1 to L5 are drawn in the first color (for example, red) on the distance map. When two measurement points measured by adjacent beams among the plurality of beams are not present in the protection area 300, a line segment connecting the two measurement points is drawn in a second color (for example, green) on the distance map. As illustrated in FIG. 4, since the seventh and eighth measurement points are not present in the protection area 300, the line segment L7 is drawn in the second color (for example, green) on the distance map.

As illustrated in FIG. 4, when the sixth measurement point is present in the protection area 300 and the seventh measurement point is not present in the protection area 300, the color of the line segment L6 is determined based on the seventh measurement point which is farther from the sensor 2 than the sixth measurement point. Therefore, on the distance map, the line segment L6 is drawn in the second color (for example, green).

The object 401 is irradiated with beams B9 to B15. A measurement point measured by the beam B9 (hereinafter also referred to as a ninth measurement point) and a measurement point measured by the beam B10 (hereinafter also referred to as a tenth measurement point) are connected by a line segment L8. The measurement point measured by the beam B10 and a measurement point measured by the beam B11 (hereinafter also referred to as an eleventh measurement point) are connected by a line segment L9. The measurement point measured by the beam B11 and a measurement point measured by the beam B12 (hereinafter also referred to as a twelfth measurement point) are connected by a line segment L10. The measurement point measured by the beam B12 and a measurement point measured by the beam B13 (hereinafter also referred to as a thirteenth measurement point) are connected by a line segment L11. The measurement point measured by the beam B13 and a measurement point measured by the beam B14 (hereinafter also referred to as a fourteenth measurement point) are connected by a line segment L12. The measurement point measured by the beam B14 and a measurement point measured by the beam B15 (hereinafter also referred to as a fifteenth measurement point) are connected by a line segment L13.

As illustrated in FIG. 4, since the ninth to eleventh measurement points and the thirteenth to fifteenth measurement points are present in the protection area 300, the line segments L8, L9, L12, and L13 are drawn in the first color (for example, red) on the distance map. The beam B12 is an invalid beam. The invalid beam is a beam whose measurement point is forcibly determined to be present in the protection area 300 due to the influence of uncorrectable noise. However, since the distance of the invalid beam is treated as infinity, it is assumed that the measurement point of the invalid beam is present outside the protection area 300. The determination unit 34 determines whether or not the invalid beam is included in the plurality of beams. The invalid beam is an example of the abnormal beam.

When one or both of two measurement points measured by adjacent beams among the plurality of beams are measured by the invalid beam, a line segment connecting the two measurement points is drawn in a third color (for example, yellow) on the distance map. As illustrated in FIG. 4, one (twelfth measurement point) of the two measurement points (eleventh and twelfth measurement points) measured by adjacent beams among the plurality of beams is measured by the invalid beam. Therefore, on the distance map, the line segment L10 connecting the eleventh measurement point and the twelfth measurement point is drawn in the third color (for example, yellow). As illustrated in FIG. 4, one (twelfth measurement point) of the two measurement points (twelfth and thirteenth measurement points) measured by adjacent beams among the plurality of beams is measured by the invalid beam. Therefore, on the distance map, the line segment L11 connecting the twelfth measurement point and the thirteenth measurement point is drawn in the third color (for example, yellow).

Further, when one or both of two measurement points measured by adjacent beams among the plurality of beams are measured by an unstable beam, a line segment connecting the two measurement points is drawn in a fourth color (for example, blue) on the distance map. The unstable beam is a beam in which the influence of noise has been corrected. The determination unit 34 determines whether or not the unstable beam is included in the plurality of beams. The unstable beam is an example of the abnormal beam.

Although a case where the beam B12 is the invalid beam has been described above, when the beam B12 is the unstable beam, the line segment L11 and the line segment L12 are drawn in the distance map as follows. A case where one (twelfth measurement point) of the two measurement points (eleventh and twelfth measurement points) measured by adjacent beams among the plurality of beams is measured by the unstable beam will be described. In this case, on the distance map, the line segment L10 connecting the eleventh measurement point and the twelfth measurement point is drawn in the fourth color (for example, blue). A case where one (twelfth measurement point) of the two measurement points (twelfth and thirteenth measurement points) measured by adjacent beams among the plurality of beams is measured by the unstable beam will be described. In this case, on the distance map, the line segment L11 connecting the twelfth measurement point and the thirteenth measurement point is drawn in the fourth color (for example, blue).

As illustrated in FIG. 4, the distance map is expressed by the line segments each connecting two measurement points measured by adjacent beams among the plurality of beams other than the abnormal beam, and the line segments each connecting a measurement point measured by the abnormal beam among the plurality of beams, and a measurement point measured by a beam adjacent to the abnormal beam among the plurality of beams. The color of the line segment connecting the two measurement points measured by the adjacent beams among the plurality of beams other than the abnormal beam is different from the color of the line segment connecting the measurement point measured by the abnormal beam among the plurality of beams, and the measurement point measured by the beam adjacent to the abnormal beam among the plurality of beams. The line segment connecting the two measurement points measured by the adjacent beams among the plurality of beams other than the abnormal beam is an example of the first line segment. The line segment connecting the measurement point measured by the abnormal beam among the plurality of beams, and the measurement point measured by the beam adjacent to the abnormal beam among the plurality of beams is an example of the second line segment. Hereinafter, the line segment connecting the measurement point measured by the abnormal beam among the plurality of beams, and the measurement point measured by the beam adjacent to the abnormal beam among the plurality of beams is referred to as a line segment caused by an abnormal beam.

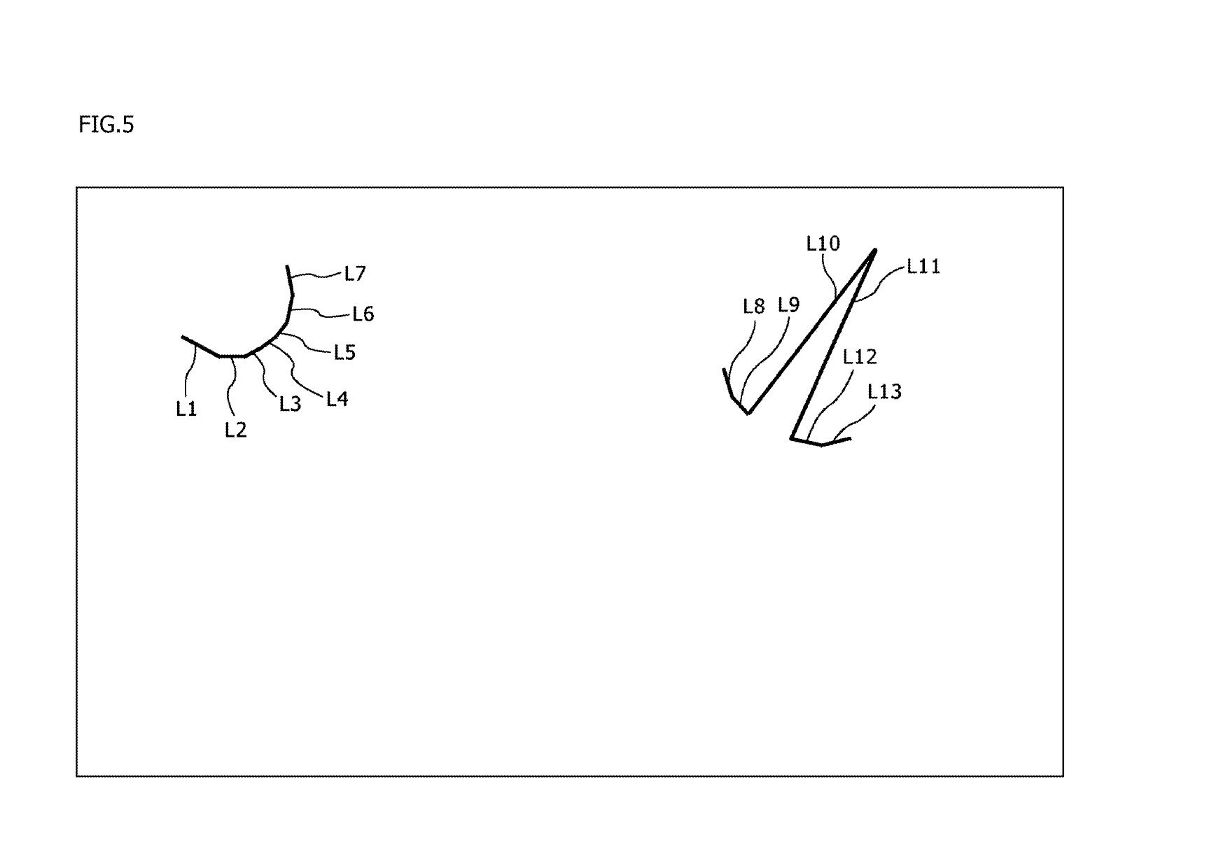

In the example illustrated in FIG. 4, the distance map displayed on the display unit 37 is expressed by at least the line segments L1 to L13. FIG. 5 is a diagram illustrating an example of the distance map expressed by the line segments L1 to L13. When the distance map illustrated in FIG. 5 is displayed on the display unit 37, distance information may be displayed on the display unit 37 together with the distance map. On the distance map, the line segments L1 to L5, L8, L9, L12, and L13 are drawn in the first color (for example, red), the line segments L6 and L7 are drawn in the second color (for example, green), and the line segments L10 and L11 are drawn in the third color (for example, yellow).

For example, even when one of the plurality of beams is the invalid beam, the line segment caused by the invalid beam is reliably drawn on the distance map. Since the line segments L10 and L11 are drawn in the third color (for example, yellow) on the distance map, the user can reliably ascertain that an invalid beam has been generated, by visually checking the distance map displayed on the display unit 37.

Although the protection area 300 is set in FIG. 4, the configuration is not limited to this example, and a warning area may be set. The warning area is set by the area setting unit 36. For example, when the first to sixth measurement points are present in the warning area, the line segments L1 to L5 are drawn in a fifth color (for example, orange) on the distance map. When an object is detected in the warning area, a warning is issued. When an object enters the warning area, the sensor 2 may issue the warning. A warning lamp may be used to issue the warning by light. A warning buzzer may be used to issue the warning by sound. When an object enters the warning area, the sensor 2 may output a warning signal. A warning device may receive the warning signal from the sensor 2 and issue the warning. Further, when an object is detected in the warning area, the speed of operation of the mobile robot 1 may be reduced. For example, when an object is present in the warning area, the sensor 2 outputs, to the mobile robot 1, a control signal for decelerating the operation of the mobile robot 1. As the color of the line segment in the distance map, light blue indicating a state in which entry has not been detected within the maximum detection distance, or yellow green indicating the edge of a detection range may be used.

The distance map generation unit 31 generates the distance map with respect to the light scanned by the sensor 2, based on the distance to the object measured using the plurality of beams sampled at the second angular interval. The second angular interval is, for example, from 0.1 degrees to 10 degrees, but is not limited thereto. Further, the second angular interval can be changed in increments of 0.1 degrees. When the second angular interval is large, the distance between two measurement points measured by adjacent beams among the plurality of beams is long. When the second angular interval is small, the distance between two measurement points measured by adjacent beams among the plurality of beams is short.

The display control unit 32 displays the distance map on the display unit 37 and updates the distance map displayed on the display unit 37 in the predetermined display cycle. Since the distance map is displayed on the display unit 37, the user can ascertain the measurement state of the sensor 2. The predetermined display cycle is, for example, from 10 msec to 3000 msec, but is not limited thereto. Further, the predetermined display cycle can be changed in increments of 1 msec. When the predetermined display cycle is short, the update cycle of the distance map displayed on the display unit 37 is short. When the update cycle of the distance map displayed on the display unit 37 is short, the number of updates of the distance map per unit time is large. When the predetermined display cycle is long, the update cycle of the distance map displayed on the display unit 37 is long. When the update cycle of the distance map displayed on the display unit 37 is long, the number of updates of the distance map per unit time is small.

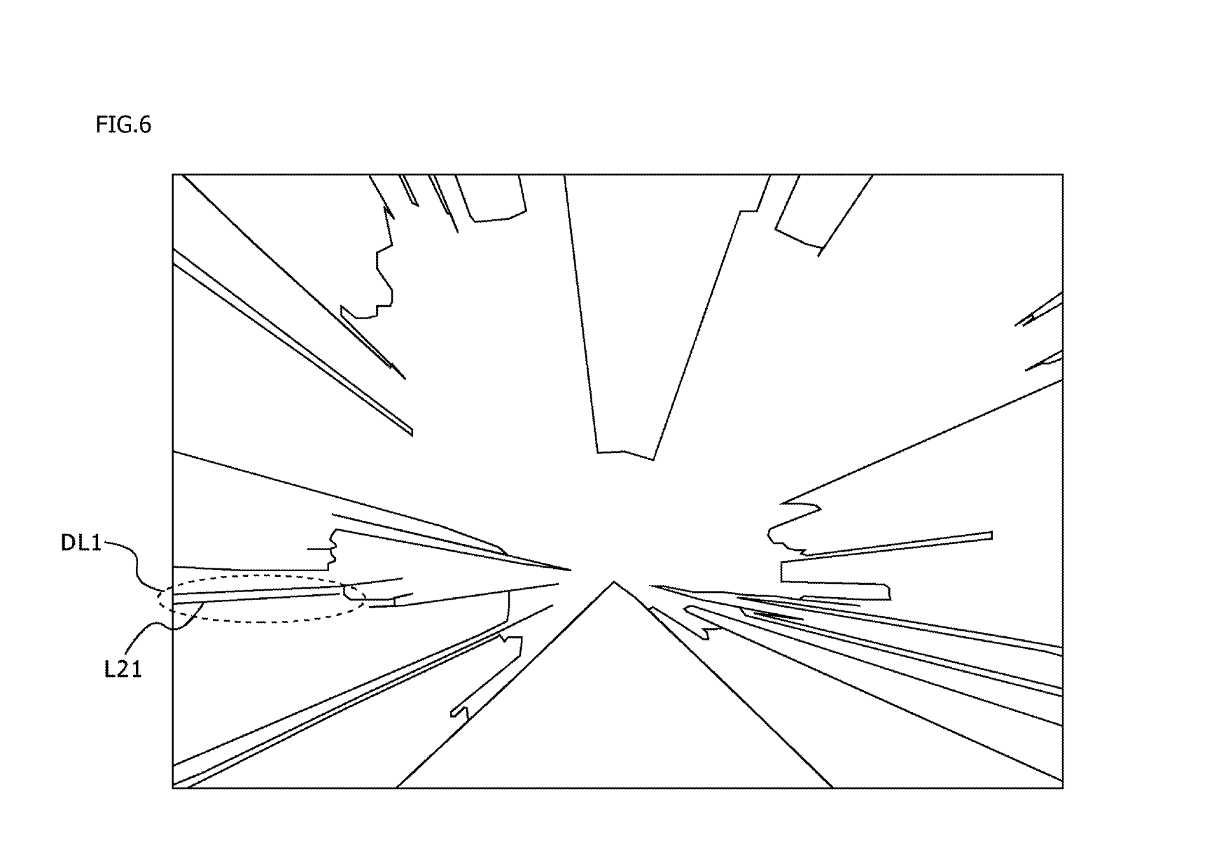

A case where the second angular interval is small and the predetermined display cycle is short (the update cycle is short) will be described. FIG. 6 is a diagram illustrating an example of the distance map. FIG. 6 illustrates an example of the distance map generated when the second angular interval is small and the predetermined display cycle is short. The distance map illustrated in FIG. 6 is expressed by line segments connecting measurement points measured by a large number of beams output from the sensor 2. It is assumed that the distance map generated when the second angular interval is small and the predetermined display cycle is short is used for applications (1A) to (1C) described below.

(1A) To check whether or not disturbance light or noise has been generated and predict the cause thereof before a system stops.

(1B) To identify a location at which the disturbance light or noise has been generated, in order to produce a precautionary measure.

(1C) To monitor an accurate shape of an object.

When the second angular interval is small and the predetermined display cycle is short, there is a high possibility that the line segment caused by the abnormal beam is included in the distance map. By reducing the second angular interval and shortening the predetermined display cycle, it is possible to accurately detect the presence or absence of the abnormal beam. Therefore, the user can check whether or not the disturbance light or noise has been generated. Further, by reducing the second angular interval and shortening the predetermined display cycle, the position of the abnormal beam can be accurately detected. As a result, the user can identify the location at which the disturbance light or noise has been generated. When the second angular interval is small and the predetermined display cycle is short, the accurate shape of the object is reflected in the distance map. Thus, the user can monitor the accurate shape of the object.

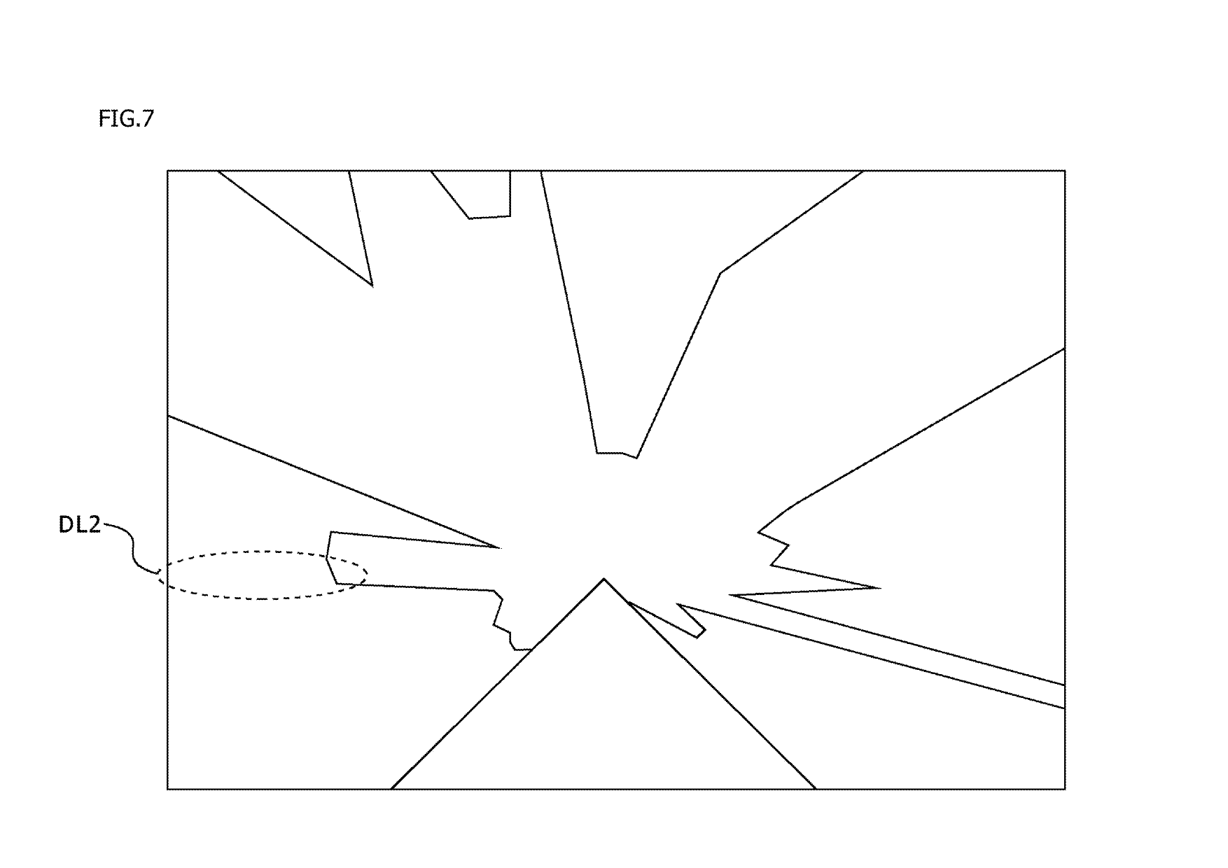

A case where the second angular interval is large and the predetermined display cycle is long (the update cycle is long) will be described. FIG. 7 is a diagram illustrating an example of the distance map. FIG. 7 illustrates an example of the distance map generated when the second angular interval is large and the predetermined display cycle is long. It is assumed that the distance map generated when the second angular interval is large and the predetermined display cycle is long is used for applications (2A) and (2B) described below.

(2A) To reduce the processing load of a setting tool.

(2B) To reduce the possibility of a noise signal being drawn, in order to ascertain a rough shape of an object.

When the second angular interval is small and the predetermined display cycle is short, the processing load of the setting tool is large. On the other hand, when the second angular interval is large and the predetermined display cycle is long, the processing load of the setting tool is small. By increasing the second angular interval and lengthening the predetermined display cycle, the processing load of the setting tool is reduced.

In the distance map illustrated in FIG. 6, a line segment L21 connecting measurement points measured by invalid beams are present in a range surrounded by a dotted line DL1. On the other hand, in the distance map illustrated in FIG. 7, a line segment connecting measurement points measured by invalid beams is not present in a range surrounded by a dotted line DL2. In a case where the second angular interval is large and the predetermined display cycle is long, there is a low possibility that the line segment caused by the abnormal beam is included in the distance map. By increasing the second angular interval and lengthening the predetermined display cycle, the invalid beam is filtered in the distance map illustrated in FIG. 7, and thus, the line segment caused by the invalid beam is not included in the distance map of FIG. 7. Note that other filtering methods may be used to filter the invalid beam. The user may select one of a plurality of filtering methods.

When the second angular interval is large and the predetermined display cycle is long, the rough shape of the object is reflected in the distance map. By increasing the second angular interval and lengthening the predetermined display cycle, the user can ascertain the rough shape of the object.

A case where the second angular interval is small and the predetermined display cycle is long (the update cycle is long) will be described. It is assumed that the distance map generated when the second angular interval is small and the predetermined display cycle is long is used for an application (3A) described below.

(3A) To reduce the processing load of a setting tool while monitoring an accurate shape of an object.

When the predetermined display cycle is long, the processing load of the setting tool is small. By lengthening the predetermined display cycle, the processing load of the setting tool is reduced. When the second angular interval is small, the distance map reflects the accurate shape of the object. Thus, the user can monitor the accurate shape of the object.

For example, when the user checks whether or not disturbance light or noise has been generated, the user inputs, to the reception unit 35, an instruction to reduce the second angular interval and shorten the predetermined display cycle. The setting unit 33 sets the second angular interval and the predetermined display cycle so as to reduce the second angular interval and shorten the predetermined display cycle in accordance with the user's instruction received by the reception unit 35. A first threshold value related to the second angular interval and a second threshold value related to the predetermined display cycle may be set. The user may input, to the reception unit 35, an instruction to cause the second angular interval to be smaller than the first threshold value and cause the predetermined display cycle to be smaller than the second threshold value. The setting unit 33 may set the second angular interval and the predetermined display cycle so as to cause the second angular interval to be smaller than the first threshold value and cause the predetermined display cycle to be smaller than the second threshold value in accordance with the user's instruction received by the reception unit 35.

For example, when the user desires to reduce the possibility of the noise signal being drawn, the user inputs, to the reception unit 35, an instruction to increase the second angular interval and lengthen the predetermined display cycle. The setting unit 33 sets the second angular interval and the predetermined display cycle so as to increase the second angular interval and lengthen the predetermined display cycle in accordance with the user's instruction received by the reception unit 35. The user may input, to the reception unit 35, an instruction to cause the second angular interval to be greater than the first threshold value and cause the predetermined display cycle to be greater than the second threshold value. The setting unit 33 may set the second angular interval and the predetermined display cycle so as to cause the second angular interval to be greater than the first threshold value and cause the predetermined display cycle to be greater than the second threshold value in accordance with the user's instruction received by the reception unit 35.

For example, when the user desires to reduce the processing load of the setting tool while monitoring the accurate shape of the object, the user inputs, to the reception unit 35, an instruction to reduce the second angular interval and lengthen the predetermined display cycle. The setting unit 33 sets the second angular interval and the predetermined display cycle so as to reduce the second angular interval and lengthen the predetermined display cycle in accordance with the user’s instruction received by the reception unit 35. The user may input, to the reception unit 35, an instruction to cause the second angular interval to be smaller than the first threshold value and cause the predetermined display cycle to be greater than the second threshold value. The setting unit 33 may set the second angular interval and the predetermined display cycle so as to cause the second angular interval to be smaller than the first threshold value and cause the predetermined display cycle to be greater than the second threshold value in accordance with the user's instruction received by the reception unit 35.

The user may input an instruction to reduce the second angular interval to the reception unit 35. The setting unit 33 sets the second angular interval so as to reduce the second angular interval in accordance with the user's instruction received by the reception unit 35. In this case, the setting unit 33 may set the predetermined display cycle so as to shorten the predetermined display cycle, or may set the predetermined display cycle so as to lengthen the predetermined display cycle. Further, the setting unit 33 may set the predetermined display cycle so as to set the predetermined display cycle to a first default value. The first default value is a given value, and may be a minimum value, a maximum value, or an intermediate value.

The user may input an instruction to increase the second angular interval to the reception unit 35. The setting unit 33 sets the second angular interval so as to increase the second angular interval in accordance with the user's instruction received by the reception unit 35. In this case, the setting unit 33 may set the predetermined display cycle so as to shorten the predetermined display cycle, or may set the predetermined display cycle so as to lengthen the predetermined display cycle. Further, the setting unit 33 may set the predetermined display cycle so as to set the predetermined display cycle to a first default value.

The user may input an instruction to shorten the predetermined display cycle to the reception unit 35. The setting unit 33 sets the predetermined display cycle so as to shorten the predetermined display cycle in accordance with the user's instruction received by the reception unit 35. In this case, the setting unit 33 may set the second angular interval so as to increase the second angular interval, or may set the second angular interval so as to reduce the second angular interval. Further, the setting unit 33 may set the second angular interval so as to set the second angular interval to a second default value. The second default value is a given value, and may be a minimum value, a maximum value, or an intermediate value.

The user may input an instruction to lengthen the predetermined display cycle to the reception unit 35. The setting unit 33 sets the predetermined display cycle so as to lengthen the predetermined display cycle in accordance with the user's instruction received by the reception unit 35. In this case, the setting unit 33 may set the second angular interval so as to increase the second angular interval, or may set the second angular interval so as to reduce the second angular interval. Further, the setting unit 33 may set the second angular interval so as to set the second angular interval to a second default value. The second default value is a given value, and may be a minimum value, a maximum value, or an intermediate value.

According to the setting device 3, since at least one of the second angular interval and the predetermined display cycle is set in accordance with an instruction from the user, it is possible to display, on the display unit 37, a distance map that the user desires to view. In this way, according to the setting device 3, it is possible to display information that the user desires to view.

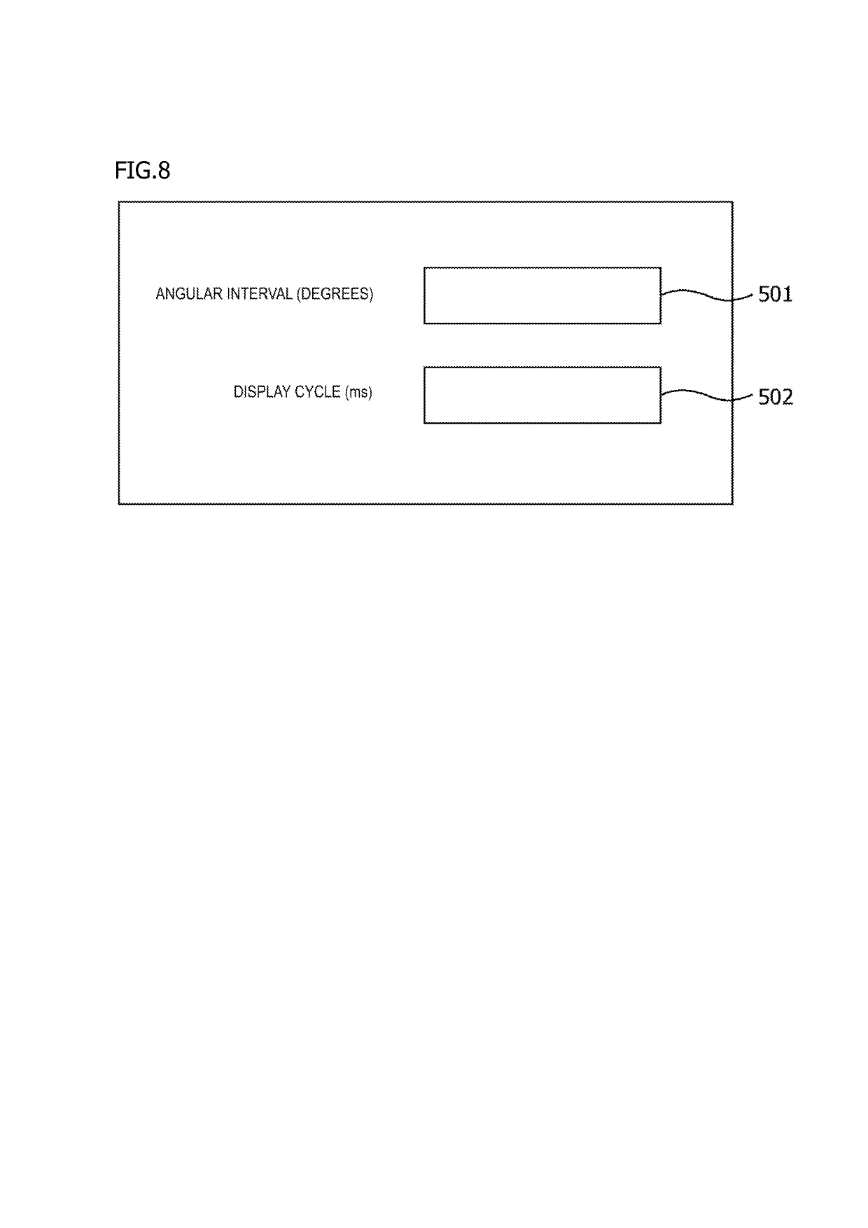

FIG. 8 is a diagram illustrating an example of a screen (setting screen) used when setting the second angular interval and the predetermined display cycle. The second angular interval input by the user is displayed in a rectangular box 501 illustrated in FIG. 8. The predetermined display cycle input by the user is displayed in a rectangular box 502 illustrated in FIG. 8.

A case where the second angular interval and the predetermined display cycle set by the setting unit 33 are in a first setting state will be described. The first setting state is a state in which the second angular interval is small and the predetermined display cycle is short.

For example, in the first setting state, when the user desires to reduce the possibility of the noise signal being drawn, the user inputs, to the reception unit 35, a change instruction to increase the second angular interval and lengthen the predetermined display cycle. The setting unit 33 changes the settings of the second angular interval and the predetermined display cycle so as to increase the second angular interval and lengthen the predetermined display cycle in accordance with the change instruction from the user. The user may input, to the reception unit 35, a change instruction to cause the second angular interval to be greater than the first threshold value and cause the predetermined display cycle to be greater than the second threshold value. The setting unit 33 may change the settings of the second angular interval and the predetermined display cycle so as to cause the second angular interval to be greater than the first threshold value and cause the predetermined display cycle to be greater than the second threshold value in accordance with the change instruction from the user.

For example, in the first setting state, when the user desires to reduce the processing load of the setting tool while monitoring the accurate shape of the object, the user inputs a change instruction to lengthen the predetermined display cycle to the reception unit 35. The setting unit 33 changes the setting of the predetermined display cycle so as to lengthen the predetermined display cycle in accordance with the change instruction from the user. The user may input, to the reception unit 35, a change instruction to cause the predetermined display cycle to be greater than the second threshold value. The setting unit 33 may change the setting of the predetermined display cycle so as to cause the predetermined display cycle to be greater than the second threshold value in accordance with the change instruction from the user.

A case where the second angular interval and the predetermined display cycle set by the setting unit 33 are in a second setting state will be described. The second setting state is a state in which the second angular interval is large and the predetermined display cycle is long.

For example, in the second setting state, when the user checks whether or not disturbance light or noise has been generated, the user inputs, to the reception unit 35, a change instruction to reduce the second angular interval and shorten the predetermined display cycle. The setting unit 33 changes the settings of the second angular interval and the predetermined display cycle so as to reduce the second angular interval and shorten the predetermined display cycle in accordance with the change instruction from the user. The user may input, to the reception unit 35, a change instruction to cause the second angular interval to be smaller than the first threshold value and cause the predetermined display cycle to be smaller than the second threshold value. The setting unit 33 may change the settings of the second angular interval and the predetermined display cycle so as to cause the second angular interval to be smaller than the first threshold value and the predetermined display cycle to be smaller than the second threshold value in accordance with the change instruction from the user.

For example, in the second setting state, when the user desires to reduce the processing load of the setting tool while monitoring the accurate shape of the object, the user inputs a change instruction to reduce the second angular interval to the reception unit 35. The setting unit 33 changes the setting of the second angular interval so as to reduce the second angular interval in accordance with the user's instruction received by the reception unit 35. The user may input, to the reception unit 35, a change instruction to cause the second angular interval to be smaller than the first threshold value. The setting unit 33 may change the setting of the second angular interval so as to cause the second angular interval to be smaller than the first threshold value in accordance with the change instruction from the user.

A case where the second angular interval and the predetermined display cycle set by the setting unit 33 are in a third setting state will be described. The third setting state is a state in which the second angular interval is small and the predetermined display cycle is long.

For example, in the third setting state, when the user checks whether or not disturbance light or noise has been generated, the user inputs a change instruction to shorten the predetermined display cycle to the reception unit 35. The setting unit 33 changes the setting of the predetermined display cycle so as to shorten the predetermined display cycle in accordance with the change instruction from the user. The user may input, to the reception unit 35, a change instruction to cause the predetermined display cycle to be smaller than the second threshold value. The setting unit 33 may change the setting of the predetermined display cycle so as to cause the predetermined display cycle to be smaller than the second threshold value in accordance with the change instruction from the user.

For example, in the third setting state, when the user desires to reduce the possibility of the noise signal being drawn, the user inputs a change instruction to increase the second angular interval to the reception unit 35. The setting unit 33 changes the setting of the second angular interval so as to increase the second angular interval in accordance with the change instruction from the user. The user may input, to the reception unit 35, a change instruction to cause the second angular interval to be greater than the first threshold value. The setting unit 33 may change the setting of the second angular interval so as to cause the second angular interval to be greater than the first threshold value in accordance with the change instruction from the user.

The reception unit 35 receives, from the user, a change instruction to change the setting of at least one of the second angular interval and the predetermined display cycle. The setting unit 33 changes the setting of at least one of the second angular interval and the predetermined display cycle in accordance with the change instruction received by the reception unit 35. According to the setting device 3, since the setting of at least one of the second angular interval and the predetermined display cycle is changed in accordance with the user's instruction, it is possible to display, on the display unit 37, the distance map that the user desires to view. In this way, according to the setting device 3, it is possible to display information that the user desires to view.

The settings and changes of the settings of the second angular interval and the predetermined display cycle do not affect the setting of the first angular interval for the sensor 2. The display state of the distance map on the display unit 37 is determined in accordance with the settings of the second angular interval and the predetermined display cycle. However, the setting of the first angular interval for the sensor 2 is not affected by the settings of the second angular interval and the predetermined display cycle, and thus the setting of the first angular interval for the sensor 2 is not changed. When the setting of at least one of the second angular interval and the predetermined display cycle is changed, the display state of the distance map on the display unit 37 is affected, but the setting of the first angular interval for the sensor 2 is not affected, and thus the setting of the first angular interval for the sensor 2 is not changed. Therefore, even if settings are made for the second angular interval and the predetermined display cycle, or the settings of the second angular interval and the predetermined display cycle are changed, there is no impact on object detection processing in the sensor 2, and further, there is no impact on safety control in the sensor 2.

The reception unit 35 receives a selection of display or non-display of the line segment in accordance with types of the plurality of beams. The display control unit 32 switches between display and non-display of the line segment on the display unit 37 based on the selection of display or non-display of the line segment. By switching between display and non-display of the line segment on the display unit 37, only the line segment that the user desires to view can be displayed on the display unit 37. For example, the user inputs, to the reception unit 35, an instruction (selection) to display the line segment caused by the abnormal beam. In this case, the display control unit 32 displays the line segment caused by the abnormal beam on the display unit 37. Therefore, the distance map displayed on the display unit 37 includes the line segment caused by the abnormal beam. For example, the user inputs, to the reception unit 35, an instruction (selection) to hide the line segment caused by the abnormal beam. In this case, the display control unit 32 does not display the line segment caused by the abnormal beam on the display unit 37. Therefore, the distance map displayed on the display unit 37 does not include the line segment caused by the abnormal beam. By switching between display and non-display of the line segment caused by the abnormal beam on the display unit 37, it is possible to display the line segment caused by the abnormal beam on the display unit 37, or not to display the line segment caused by the abnormal beam on the display unit 37. The user can check whether or not disturbance light or noise has been generated by selecting display of the line segment caused by the abnormal beam. The user can monitor the shape of the object more accurately by selecting non-display of the line segment caused by the abnormal beam. The display control unit 32 may display the distance map on the display unit 37 while replacing the hidden line segment (line segment caused by the abnormal beam) with another line segment. Further, the distance map generation unit 31 may generate a distance map by replacing the hidden line segment with another line segment, and the display control unit 32 may display that distance map on the display unit 37. The other line segment may be estimated based on the line segment (first line segment) connecting two measurement points measured by adjacent beams other than the abnormal beam among the plurality of beams.

The storage unit 38 stores display settings related to the distance map displayed on the display unit 37. The display settings related to the distance map may include the second angular interval and the predetermined display cycle set by the setting unit 33. Further, the display settings related to the distance map may include the settings of the second angular interval and the predetermined display cycle changed by the setting unit 33. The display settings related to the distance map may include the display and non-display settings of the line segment caused by the abnormal beam. After the setting tool is restarted, the display control unit 32 may display the distance map on the display unit 37 based on the display settings stored in the storage unit 38. Accordingly, after the setting tool is restarted, the user can check the distance map based on the display settings stored in the storage unit 38. Thus, after the setting tool is restarted, the user can perform work in a state of the setting tool before the restart.

The display control unit 32 may simultaneously display, on the display unit 37, the distance map and a detection area setting screen. Examples of the detection area setting screen include a screen for setting the shape of the detection area and a screen for setting an area set including one or a plurality of the detection areas. With the distance map and the detection area setting screen simultaneously displayed on the display unit 37, the user can visually check the detection area setting screen while checking the distance map. For example, the user can set the shape of the detection area or set the area set while ascertaining the measurement state of the sensor 2.

The detection area is set independently of the second angular interval and the predetermined display cycle. Therefore, the settings of the second angular interval and the predetermined display cycle and the change of the setting do not affect the setting of the detection area. The display state of the distance map on the display unit 37 is determined in accordance with the settings of the second angular interval and the predetermined display cycle, but the setting of the detection area is not changed. When the setting of at least one of the second angular interval and the predetermined display cycle is changed, the display state of the distance map on the display unit 37 is affected by the change, but the setting of the detection area is not affected and thus the setting of the detection area is not changed.

Although an example in which the sensor 2 is installed at the mobile robot 1 is described above, the configuration is not limited to this example. The sensor 2 may be installed at a fixed hazard such as a fixed robot or a manufacturing machine, or may be installed around the fixed hazard. A plurality of the sensors 2 may be used. Setting information set for the sensor 2 installed at a first fixed hazard may be the same as or different from setting information set for the sensor 2 installed at s second fixed hazard.

The sensor 2 and the setting device 3 may be integrated with each other. For example, the sensor 2 may include the setting device 3. The sensor 2 may be constituted by installing a setting tool on a processing device of the sensor 2. The display 211 of the sensor 2 may function as a display unit (display device).

The present invention can also be regarded as a setting method or a monitoring method including at least a portion of the processing described above, a program for causing a computer to execute at least a portion of the processing described above, or a computer-readable storage medium having such a program recorded in a non-transitory manner. Further, the present invention can be regarded as a setting system or a monitoring system including at least a portion of the processing described above. The configurations and processing described above can be combined with each other to configure the present invention as long as no technical contradiction arises.

### Supplementary Note 1

A setting device (3) for a sensor (2) that measures a distance to an object by two-dimensionally scanning light at a first angular interval, the setting device (3) including: a distance map generation unit (31) configured to generate a distance map with respect to the light that is scanned, based on a measured distance to the object and using a plurality of beams sampled at a second angular interval; a display control unit (32) configured to update the distance map displayed on a display unit (38) in a predetermined display cycle; a reception unit (35) configured to receive an instruction of a user; and a setting unit (33) configured to set at least one of the second angular interval and the predetermined display cycle in accordance with the instruction of the user received by the reception unit (35).

### Supplementary Note 2

The setting device (3) according to Supplementary Note 1, in which the reception unit (35) receives, from the user, a change instruction to change a setting of at least one of the second angular interval and the predetermined display cycle, and the setting unit (33) changes the setting of at least one of the second angular interval and the predetermined display cycle in accordance with the change instruction received by the reception unit (35).

### Supplementary Note 3

The setting device (3) according to Supplementary Note 1 or 2, in which the distance map is expressed by a line segment connecting two measurement points measured by adjacent beams among the plurality of beams sampled.

### Supplementary Note 4

The setting device (3) according to Supplementary Note 3, in which the reception unit (35) receives a selection of display or non-display of the line segment in accordance with a type of the plurality of beams, and the display control unit (32) switches between display and non-display of the line segment on the display unit (38) based on the selection of display or non-display of the line segment.

### Supplementary Note 5

The setting device (3) according to any one of Supplementary Notes 1 to 4, including a determination unit (34) configured to determine whether or not an abnormal beam is present in the plurality of beams, in which the distance map is expressed by a first line segment connecting two measurement points measured by adjacent beams among the plurality of beams other than the abnormal beam, and by a second line segment connecting a measurement point measured by the abnormal beam among the plurality of beams, and a measurement point measured by a beam adjacent to the abnormal beam among the plurality of beams, and a color of the first line segment is different from a color of the second line segment.

### Supplementary Note 6

The setting device (3) according to Supplementary Note 5, in which the reception unit (35) receives a selection of display or non-display of the second line segment, and the display control unit (32) switches between display and non-display of the second line segment on the display unit (38) based on the selection of display or non-display of the second line segment.

### Supplementary Note 7

The setting device (3) according to any one of Supplementary Notes 1 to 6, including a storage unit (39) configured to store a display setting related to the distance map displayed on the display unit (38), in which after a setting tool is restarted, the display control unit (32) displays the distance map on the display unit (38) based on the display setting stored in the storage unit (39).

### Supplementary Note 8

The setting device (3) according to any one of Supplementary Notes 1 to 7, in which the display control unit (32) simultaneously displays, on the display unit (38), the distance map and a setting screen of a detection area for detecting entry of the object.

### Supplementary Note 9

The setting device (3) according to any one of Supplementary Notes 1 to 8, including an area setting unit (36) configured to set a detection area for detecting entry of the object, in which the detection area is set independently of the second angular interval and the predetermined display cycle.

### Supplementary Note 10

A sensor (2) including the setting device (3) according to any one of Supplementary Notes 1 to 9.

### Supplementary Note 11

A setting method for a sensor (2) that measures a distance to an object by two-dimensionally scanning light at a first angular interval, the setting method including: generating a distance map with respect to the light that is scanned, based on a measured distance to the object and using a plurality of beams sampled at a second angular interval; controlling display to update the distance map displayed on a display unit (38) in a predetermined display cycle; receiving an instruction of a user; and setting at least one of the second angular interval and the predetermined display cycle in accordance with the instruction of the user received in the receiving.

### Supplementary Note 12

A program for causing a computer, included in a setting device (3) for a sensor (2) that measures a distance to an object by two-dimensionally scanning light at a first angular interval, to execute: generating a distance map with respect to the light that is scanned, based on a measured distance to the object and using a plurality of beams sampled at a second angular interval; controlling display to update the distance map displayed on a display unit (38) in a predetermined display cycle; receiving an instruction of a user; and setting at least one of the second angular interval and the predetermined display cycle in accordance with the instruction of the user received in the receiving.

1. A setting device for a sensor that measures a distance to an object by two-dimensionally scanning light at a first angular interval, the setting device comprising:
a distance map generation unit configured to generate a distance map with respect to the light that is scanned, based on a measured distance to the object and using a plurality of beams sampled at a second angular interval;
a display control unit configured to update the distance map displayed on a display unit in a predetermined display cycle;
a reception unit configured to receive an instruction of a user; and
a setting unit configured to set at least one of the second angular interval and the predetermined display cycle in accordance with the instruction of the user received by the reception unit.

2. The setting device according to claim 1, wherein
the reception unit receives, from the user, a change instruction to change a setting of at least one of the second angular interval and the predetermined display cycle, and
the setting unit changes the setting of at least one of the second angular interval and the predetermined display cycle in accordance with the change instruction received by the reception unit.

3. The setting device according to claim 1, wherein the distance map is expressed by a line segment connecting two measurement points measured by adjacent beams among the plurality of beams sampled.

4. The setting device according to claim 3, wherein
the reception unit receives a selection of display or non-display of the line segment in accordance with a type of the plurality of beams, and
the display control unit switches between display and non-display of the line segment on the display unit based on the selection of display or non-display of the line segment.

5. The setting device according to claim 1, comprising
a determination unit configured to determine whether or not an abnormal beam is present in the plurality of beams, wherein
the distance map is expressed by a first line segment connecting two measurement points measured by adjacent beams among the plurality of beams other than the abnormal beam, and by a second line segment connecting a measurement point measured by the abnormal beam among the plurality of beams, and a measurement point measured by a beam adjacent to the abnormal beam among the plurality of beams, and
a color of the first line segment is different from a color of the second line segment.

6. The setting device according to claim 5, wherein
the reception unit receives a selection of display or non-display of the second line segment, and
the display control unit switches between display and non-display of the second line segment on the display unit based on the selection of display or non-display of the second line segment.

7. The setting device according to claim 1, comprising a storage unit configured to store a display setting related to the distance map displayed on the display unit, wherein after a setting tool is restarted, the display control unit displays the distance map on the display unit based on the display setting stored in the storage unit.

8. The setting device according to claim 1, wherein the display control unit simultaneously displays, on the display unit, the distance map and a setting screen of a detection area for detecting entry of the object.

9. The setting device according to claim 1, comprising an area setting unit configured to set a detection area for detecting entry of the object, wherein the detection area is set independently of the second angular interval and the predetermined display cycle.

10. A sensor comprising the setting device according to claim 1.

11. A setting method for a sensor that measures a distance to an object by two-dimensionally scanning light at a first angular interval, the setting method comprising:
generating a distance map with respect to the light that is scanned, based on a measured distance to the object and using a plurality of beams sampled at a second angular interval;
controlling display to update the distance map displayed on a display unit in a predetermined display cycle;
receiving an instruction of a user; and
setting at least one of the second angular interval and the predetermined display cycle in accordance with the instruction of the user received in the receiving.

12. A non-transitory computer readable medium storing a program for causing a computer, included in a setting device for a sensor that measures a distance to an object by two-dimensionally scanning light at a first angular interval, to execute:
generating a distance map with respect to the light that is scanned, based on a measured distance to the object and using a plurality of beams sampled at a second angular interval;
controlling display to update the distance map displayed on a display unit in a predetermined display cycle;
receiving an instruction of a user; and
setting at least one of the second angular interval and the predetermined display cycle in accordance with the instruction of the user received in the receiving.
